(19) United States
(12) Patent Application Publication
(10) Pub. No.: US 2007/0248800 A1
(43) Pub. Date: Oct. 25, 2007

(54) Multilayer board having layer configuration indicator portion

(75) Inventors: Chihiro Mitsui, Echizen-city (JP); Chikara Shimada, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/785,794

(22) Filed: Apr. 20, 2007

(30) Foreign Application Priority Data
Apr. 25, 2006 (JP) 2006-120209

(51) Int. Cl. B32B 3/00

(52) U.S. Cl. 428/209

(57) ABSTRACT

The invention provides a layer configuration indicator portion enabling the configuration of layers to be identified easily in a multilayer board. The configuration of the respective layers of a multilayer board can be identified easily by applying two copper foils per a single layer for a number corresponding to the number of layers constituting the multilayer board on an outer layer of the multilayer board, by which layer configuration identification marks are composed, and displaying a maximum of six types of configurations per each layer by having three types of statuses indicated on the layer configuration indication marks, which are “covering the mark with resist”, “covering the mark with resist and silk”, and “not covering the mark with resist or silk”.

The present application is based on and claims priority of Japanese patent application No. 2006-120209 filed on Apr. 25, 2006, the entire contents of which are hereby incorporated by reference.

### BACKGROUND OF THE INVENTION

1. Field of the Invention

The present invention relates to a multilayer board having a layer configuration indicator portion that enables to easily identify the configuration of each layer of a multilayer board.

2. Description of the Related Art

Conventionally, in a circuit board constituting an electronic device and the like, a multilayer board composed of a plurality of layers having different operations and objects are used widely. In a multilayer board, the inner layers cannot be visually observed, so it is difficult to determine during fabrication of the multilayer board whether the configurations of the inner layers of the board are correct or not.

Japanese Patent Application Laid-Open Publications No. 7-240583 (patent document 1) and No. 8-330743 (patent document 2) disclose methods for forming holes on the inner layers of the board to enable all the inner layers to be visually observed from the outer layer of the board. Further, Japanese Patent Application Laid-Open Publication No. 2003-51650 (patent document 3) discloses a method for forming an opening to a solder resist layer of the surface layer, and providing an identification mark on a metal layer visible through the opening indicating that the layer is a metal layer.

However, though it was possible to prevent lamination leak or erroneous lamination of the inner layers of the board according to the disclosures of patent documents 1 through 3, in order to understand the configuration of the inner layers after fabricating the board, it was necessary to look at the design diagram or to disassemble the multilayer board. Therefore, if a designer wished to refer to the configuration of the existing multilayer board when designing a new multilayer board, it was extremely difficult to grasp the configuration of the existing board.

### SUMMARY OF THE INVENTION

The present invention aims at solving the problems of the prior art, by providing a multilayer board having a layer configuration indicator portion for easily identifying the configuration of each layer of the multilayer board.

A first aspect of the present invention provides a multilayer board composed of multiple layers and having a layer configuration indicator portion, comprising providing a layer configuration indicator portion by arranging at even separated intervals copper foils in rows of two and columns whose number corresponds to the number of layers of the multilayer board as layer configuration identification marks on an outer layer of the multilayer board.

According to the arrangement of aspect 1, the configuration of each layer of the multilayer board can be discriminated via the layer configuration identification mark.

A second aspect of the present invention provides the multilayer board having a layer configuration indicator portion according to aspect 1, wherein the surface of the layer configuration identification mark is in a state selected from one of the following states: covered with resist; covered with resist and silk; and not covered with resist or silk.

According to the arrangement of aspect 2, the surfaces of the layer configuration identification marks are covered with copper foil, resist, or silk, so that through an indication method using two rows of marks and three indication variations, it becomes possible to realize a maximum of six types of layer configuration indications per layer.

A third aspect of the present invention provides the multilayer board having a layer configuration indicator portion according to aspect 1 or 2, wherein the layer configuration indicator portion includes a first layer identification mark for discriminating the first layer.

According to the arrangement of aspect 3, a first layer identification mark is formed in the plurality of layer configuration identification marks to indicate which side corresponds to the first layer.

### BRIEF DESCRIPTION OF THE DRAWINGS

FIG. 1 is a partially cutaway plan view of a multilayer board illustrating a layer configuration indicator portion disposed on an outer layer according to a preferred embodiment of the present invention;

FIG. 2 is a partially cutaway view of the multilayer board showing the indicator types of the layer configuration identification marks according to the same, wherein FIG. 2(a) is a side view thereof and FIG. 2(b) is a plan view thereof; and

FIG. 3 is a partially cutaway plan view showing indication patterns of the layer configuration identification marks according to the same, wherein FIG. 3(a) shows a wiring pattern layer for signals, FIG. 3(b) shows a wiring pattern layer for signals having been subjected to impedance control process, FIG. 3(c) is a solid pattern layer for power supply, and FIG. 3(d) is a solid pattern layer for ground.

### DETAILED DESCRIPTION OF THE PREFERRED EMBODIMENTS

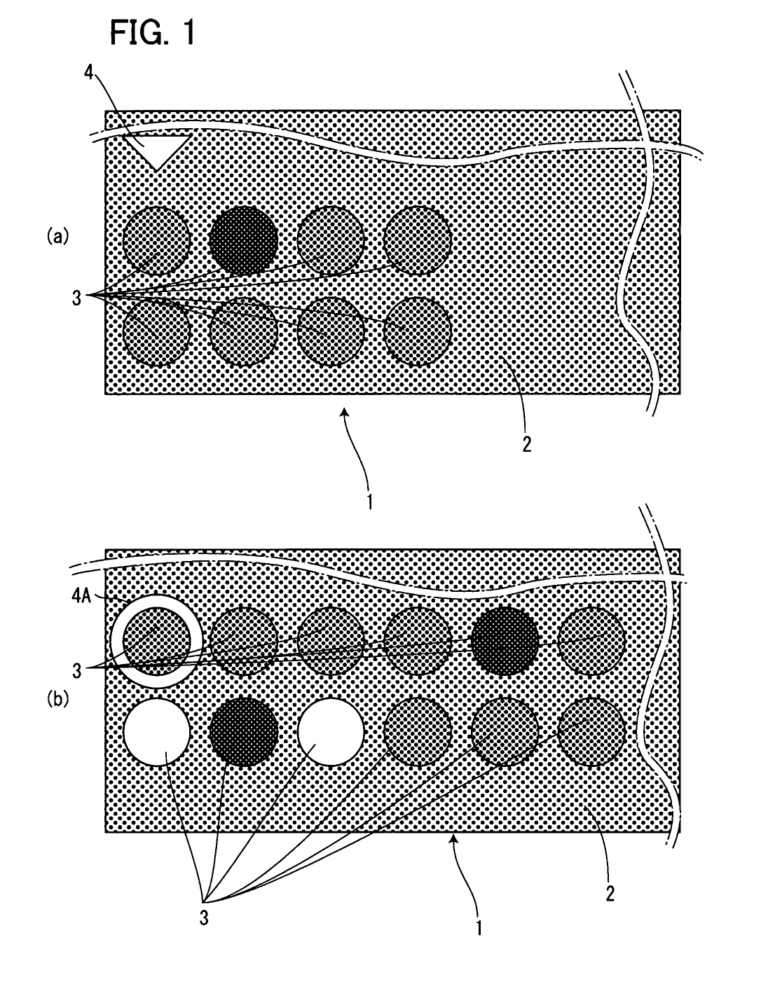

Now, the preferred embodiment for carrying out the present invention will be described with reference to FIGS. 1 through 3. Of course, the present invention is applicable to examples other than that described in the embodiment within the scope of the present invention.

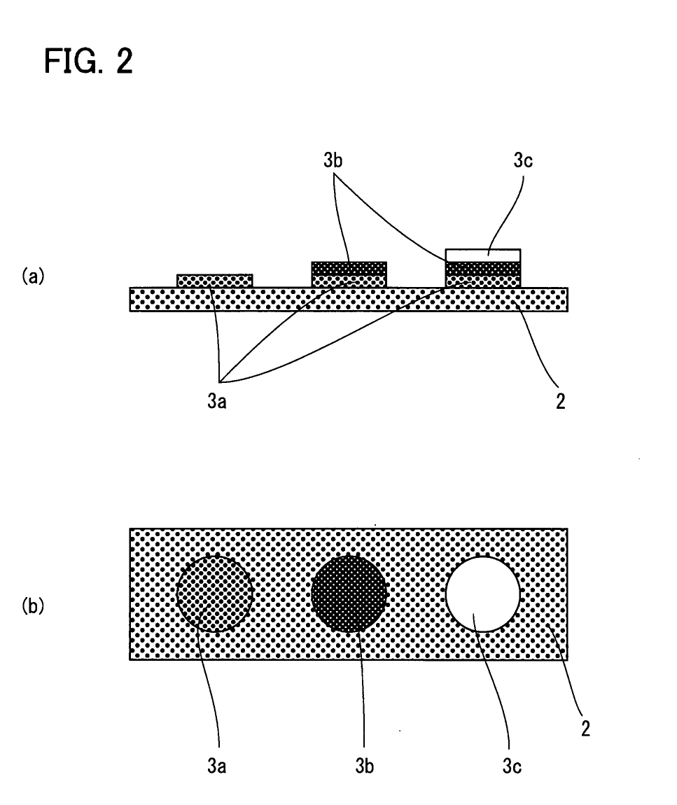

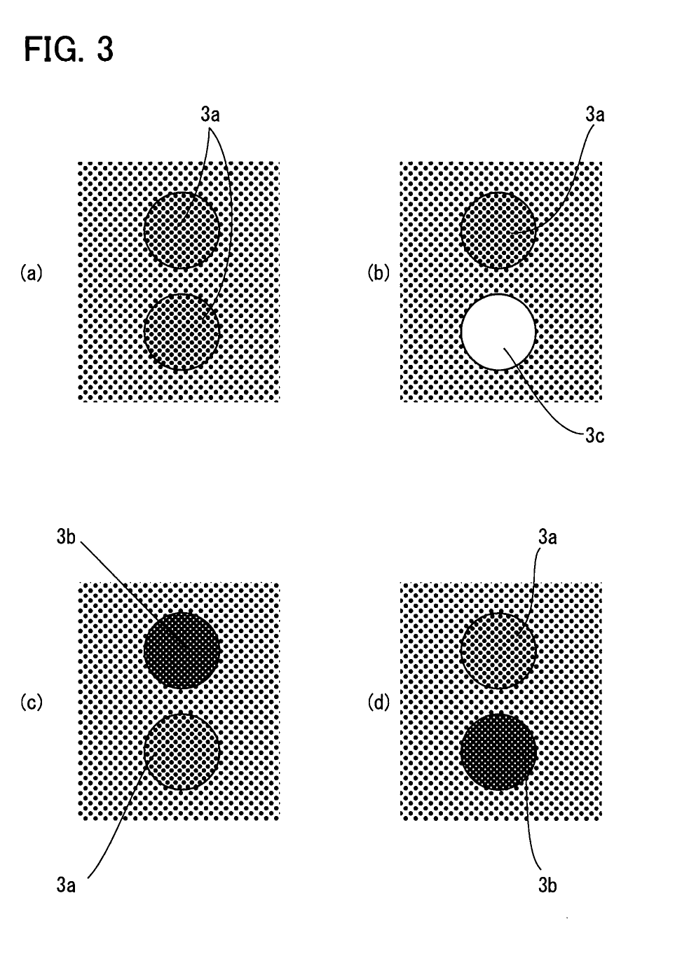

FIGS. 1 through 3 illustrate the preferred embodiment of the present invention, wherein FIG. 1 is an enlarged plan view of a multilayer board, showing the whole layer configuration indicator portion formed on an outer layer. FIG. 2 shows a state in which the layer configuration identification marks are indicated via copper foil, resist and silk, wherein FIG. 2(a) is a side view thereof and FIG. 2(b) is a plan view thereof. FIG. 3 is a plan view showing one example of the indicator types of the layer configuration identification marks.

The layer configuration indicator portion of a multilayer board according to the present embodiment will now be described with reference to FIG. 1. In FIG. 1(a), reference number 1 denotes a layer configuration indicator portion. Reference number 2 denotes a multilayer board composed of multiple layers including, for example, a wiring pattern layer for signals, a solid pattern layer for power supply, a solid pattern layer for ground, and a wiring pattern layer for signals having been subjected to impedance control. Reference number 3 denotes layer configuration identification marks, each column of which indicates the configuration of each layer. Reference number 4 denotes a first layer identification mark. The first layer identification mark 4 can be discriminated from the layer configuration identification marks 3 indicating other layers, for example, by surrounding the layer configuration identification mark 3 indicating the first layer with a serigraph or the like, as shown in 4A of FIG. 1(b).

Next, the indicator types of the layer configuration identification marks 3 are described with reference to FIG. 2. FIG. 2(a) is a side view of the layer configuration identification marks 3, and FIG. 2(b) is a plan view thereof. Reference number 3a denotes copper foil, 3b denotes resist, and 3c denotes silk. In the printing process of the multilayer board 2, three printing patterns are prepared, that are, to cover the layer configuration identification mark 3 with copper foil 3a, to cover the copper foil 3a with resist 3b, and to further cover the resist 3b with silk 3c. The three types of patterns are used in combination with two layer configuration identification marks 3, according to which a maximum of six types of layer configurations can be indicated.

Next, an example of displaying the layer configuration using the three types of layer configuration identification marks 3 is described with reference to FIG. 3. FIG. 3(a) indicates that the layer is a wiring pattern layer for signals, by applying copper foil 3a on the first row and also applying copper foil 3a on the second row. FIG. 3(b) indicates that the layer is a wiring pattern layer for signals having been subjected to impedance control, by applying copper foil 3a on the first row and applying silk 3c on the second row. FIG. 3(c) indicates that the layer is a solid pattern layer for power supply, by applying resist 3b on the first row and applying copper foil 3a on the second row. FIG. 3(d) indicates that the layer is a solid pattern layer for ground, by applying copper foil 3a on the first row and applying resist 3b on the second row. As described, by indicating two layer configuration identification marks 3 using three patterns, it becomes possible to identify the configuration of the respective layers.

According to a multilayer board 2 having such layer configuration indicator portion 1 composed as above, it becomes possible to easily identify the number of layers and the configuration of layers via the layer configuration indicator portion 1, so that a designer can easily examine the electrical operations and performances of the board. Moreover, since it is possible to identify whether the layer configuration includes a special layer, so that for example, if a solid pattern is included in the configuration, the board is subjected to greater warpage during a soldering step compared to the case in which the board does not include a solid pattern, and it becomes possible to predict such phenomenon in advance and to cope with the problem more easily. Further, when a designer wishes to refer to the multilayer board 2 having a layer configuration indicator portion 1 after the multilayer board 2 has been fabricated, the configuration of each layer of the multilayer board 2 can be discriminated without having to refer to a CAD data or other design diagram created in the design stage, so that the number of steps required for designing can be cut down.

The above describes the preferred embodiment of the present invention, but the present invention is not restricted to the preferred embodiment, and various modifications and changes are possible within the scope of the present invention. For example, the shapes of the layer configuration identification marks 3 can be other than the illustrated circle shapes, such as rectangular shapes. Moreover, there are four types of patterns of the layer configuration identification marks 3 illustrated in the present embodiment, but the number thereof is not restricted to four, and the number of types can range from one to six, depending on the number of configurations.

The effects of the present invention are as follows.

The multilayer board composed of multiple layers and having a layer configuration indicator portion according to the first aspect of the present invention comprises providing a layer configuration indicator portion by arranging at even separated intervals copper foils in rows of two and columns whose number corresponds to the number of layers of the multilayer board as layer configuration identification marks on an outer layer of the multilayer board, so that the layer configuration of the multilayer board can be discriminated via the layer configuration indicator portion without having to refer to the design data such as CAD data when designing a new board.

The multilayer board according to the second aspect of the present invention concerns the multilayer board having a layer configuration indicator portion according to aspect 1, wherein the surface of the layer configuration identification mark is in a state selected from one of the following states: covered with resist; covered with resist and silk; and not covered with resist or silk, so that the indication method using two rows and three indication types can indicate a maximum of six indicator types per a single layer. Furthermore, since copper, resist and silk are all required in the manufacturing process of a board, the layer configuration indicator portion can be formed without having to add components or steps.

The multilayer board according to the third aspect of the present invention concerns the multilayer board having a layer configuration indicator portion according to aspect 1 or aspect 2, wherein the layer configuration indicator portion includes a first layer identification mark for discriminating the first layer, so that it is easy to discriminate which column of the layer configuration identification mark corresponds to which layer of the board.

What is claimed is:

1. A multilayer board composed of multiple layers and having a layer configuration indicator portion, comprising:
providing a layer configuration indicator portion by arranging at even separated intervals copper foils in rows of two and columns whose number corresponds to the number of layers of the multilayer board as layer configuration identification marks on an outer layer of the multilayer board.

2. The multilayer board having a layer configuration indicator portion according to claim 1, wherein the surface of the layer configuration identification mark is in a state selected from one of the following states: covered with resist; covered with resist and silk; and not covered with resist or silk.

3. The multilayer board having a layer configuration indicator portion according to claim 1, wherein the layer configuration indicator portion includes a first layer identification mark for discriminating the first layer.

4. The multilayer board having a layer configuration indicator portion according to claim 2, wherein the layer configuration indicator portion includes a first layer identification mark for discriminating the first layer.

5. An electronic device equipped with the multilayer board having the layer configuration indicator portion disclosed in claim 1.

6. An electronic device equipped with the multilayer board having the layer configuration indicator portion disclosed in claim 2.

7. An electronic device equipped with the multilayer board having the layer configuration indicator portion disclosed in claim 3.

8. An electronic device equipped with the multilayer board having the layer configuration indicator portion disclosed in claim 4.
